(19) United States
(12) Patent Application Publication
(10) Pub. No.: US 2026/0097399 A1
(43) Pub. Date: Apr. 9, 2026

(54) MODULAR APPARATUS FOR TESTING MICROFLUIDIC CARTRIDGE, USEFUL FOR POINT-OF-CARE MEDICAL DIAGNOSTICS AND OTHER APPLICATIONS

(71) Applicant: Coagulo Medical Technologies, Inc., Auburndale, MA (US)

(72) Inventors: Galit H. Frydman, Boston, MA (US); Alexander H. Slocum, Bow, NH (US); Folkers E. Rojas, Buckeye, AZ (US)

(21) Appl. No.: 19/116,383

(22) PCT Filed: Sep. 29, 2023
(86) PCT No.: PCT/US2023/034139

§ 371 Date: Mar. 28, 2025

Related U.S. Application Data
(60) Provisional application No. 63/412,139, filed on Sep. 30, 2022.

(51) Int. Cl. B01L 3/00

(52) U.S. Cl. CPC B01L 3/502715; B01L 2200/025; B01L 2300/021; B01L 2300/027; B01L 2300/1805

(57) ABSTRACT

Disclosed herein are embodiments of a device, designed to receive a microfluidic cartridge, comprising alignment features that are used for aligning internal components of the device. Alignment features are also used for aligning a microfluidic cartridge that is inserted into the device, with components of the device.

### FIELD OF THE INVENTION

The present invention relates to a modular, portable apparatus for evaluating a fluid sample (e.g., a sample of a bodily fluid) contained in a microfluidic cartridge. The present invention further relates to integral alignment features for interfacing the microfluidic cartridge to the apparatus, as well as for interfacing the internal components of the apparatus. An apparatus as described herein is useful as a point-of-care medical diagnostics device, for example.

### BACKGROUND OF THE INVENTION

The coagulation system is a delicate balance between hemorrhage and thrombosis. Many disease conditions and clinical situations (such as, for example, cancer, auto-immune disease, infection, trauma, surgery, heart disease, and drug treatments) can cause a disruption of this balance and result in a patient having severe, and in some cases even life-threatening, bleeding or clotting events.

Several coagulation tests have been developed to diagnose conditions such as hemophilia, and to monitor the progress of anticoagulation therapy and other agents. Common tests include assays for prothrombin time (PT), activated partial thromboplastin time (aPTT), and activated clotting time (ACT). Other tests and testing devices have also been developed (see US 2019/0111431 A1; U.S. Pat. Nos. 10,598,675 B2; 10,534,006 B2). With respect to devices for point-of-care testing, options remain limited. There thus is a need in the art for devices suitable for point-of-care analysis of a patient's blood sample.

### SUMMARY OF THE INVENTION

Described herein are embodiments of a device comprising alignment features and configured to receive a microfluidic cartridge. The alignment features are used for aligning internal components of the device. Alignment features are also used for aligning a microfluidic cartridge that is inserted into the device, with components of the device. Such alignment features may comprise pins, slots, and/or vees and flats, as described herein. Such alignment features are useful for devices designed to test a fluid sample contained in a microfluidic cartridge; for example, a modular, portable, point-of-care medical diagnostic apparatus, used to analyze a bodily fluid sample (e.g., blood or plasma) contained in a cartridge, may comprise alignment features and other components as described herein.

In certain embodiments, one or more internal components of the device comprise slots and/or vees and flats. These slots and/or vees and flats interface with pins located on a structure in the device (e.g., the base of a device). The interfacing of one or more slots, and/or of one or more vee and flat, on a component, with one or more pins on a base of the device results in planar and rotational alignment of the component with the base of the device. In addition, a microfluidic cartridge that is inserted into the device may comprise vees and flats that interface with the pins, with such interfacing resulting in planar and rotational alignment of the microfluidic cartridge with the device (e.g., with one or more internal components of the device).

Certain embodiments of the invention relate to a device comprising a base, wherein the base comprises pins (e.g., dowel pins). Each pin interfaces with a feature on a component—with a slot or with a vee and flat geometry on a component of the device. For example, in some embodiments, the invention relates to a device comprising a base and comprising a gantry, wherein the base comprises three pins (e.g., three dowel pins) and wherein the gantry comprises three slots. The placement of the pins on the base, and of the slots in the gantry, is such that the three pins being inserted into the three slots results in planar and rotational alignment of the base and the gantry.

Embodiments of the present invention further relate to a device configured to receive a microfluidic cartridge, wherein the device comprises at least two pins (e.g., at least two dowel pins). For example, the device may comprise a base (e.g., a monolithic base) with two dowel pins. Each of the two pins is oriented on the base such that the pins interface with a vee and flat on a microfluidic cartridge that is inserted into the device. The interfacing of the pins with a vee and flat on the microfluidic cartridge results in alignment of the microfluidic cartridge with internal components of the device, such as those components that are also aligned to the two pins (via slots and/or vees and flats on the component interfacing with the pins, as described above). Alignment features as described herein allow alignment of multiple components, and of the microfluidic cartridge, to the same datum (e.g., pins as described herein).

Certain embodiments of the present invention relate to a device configured to receive a microfluidic cartridge, the device comprising: a kinematic interface for interfacing the microfluidic cartridge and the device, the kinematic interface comprising a vee and a flat (e.g., a vee and a flat on the microfluidic cartridge that interface with pins on the device); a latch that secures the microfluidic cartridge in place after the microfluidic cartridge is inserted into the device; an actuator configured to activate movement of fluid contained within the microfluidic cartridge; and a user interface. In some embodiments, the user interface comprises an LCD (liquid crystal display) and a touchscreen. In additional embodiments, the device may further comprise one or more of: a barcode reader, a clicker that generates a sound when the cartridge has been inserted, and a heater. In embodiments where the device does not contain a heater, the device may comprise a controller for controlling a heating element contained in the microfluidic cartridge.

The present invention relates to these and other important aspects, as described herein.

### BRIEF DESCRIPTION OF THE DRAWINGS

FIG. 1A shows an isometric view of the front side of a device (device 10 as described in embodiments herein).

FIG. 1B shows an isometric view of three modules (modules 1, 2, and 3) of a device, as described in embodiments herein. Module 1 is the base subassembly 2; module 2 is the gantry subassembly 3; and module 3 is the upper shell subassembly 5.

FIG. 1C shows an isometric view of a fixture (fixture 340) used to align pins (e.g., dowel pins, shown as 301A and 301B) to establish the key datum feature, as described in embodiments herein.

FIG. 1D shows an isometric view of a cartridge (cartridge 60) aligning to two pins (e.g., dowel pins, shown as 301A and 301B in this embodiment). Other features, such as latch 359, are also depicted in this figure.

FIG. 1E shows an isometric view of a cartridge (cartridge 60) and an interface board assembly (interface board 870).

FIG. 2A shows an isometric view of module 1 (base subassembly 2) components.

FIG. 2B shows a top view of module 1 (base subassembly 2) components.

FIG. 2C shows components that are actuated by the linear actuator, as described in embodiments herein.

FIG. 2D shows a cross-sectional view of a motor mount in the z plane, which includes a view of the photo interrupt switch function.

FIG. 2E shows an isometric view of a base and other components, with part of the base omitted to show a linear guide rail (linear guide rail 350) and other alignment features.

FIG. 2F shows a rear isometric cross-sectional view in a y plane where the heater arm is in the active configuration.

FIG. 2G shows the alignment surface between a carriage (carriage 351) and a carriage bracket (carriage bracket 352), as described in embodiments herein.

FIG. 3A shows an isometric view of module 2, which is the gantry subassembly 3.

FIG. 3B shows a bottom view of module 2 (the gantry subassembly 3).

FIG. 3C shows an expanded view of the components of a heater (heater 700 as described in embodiments herein).

FIG. 3D shows a side view of a heater and heater actuator components.

FIG. 3E shows an isometric view of a heater and heater actuator components.

FIG. 3F shows a cross-sectional side view of a heater mechanism in the undeployed state with components hidden for clarity.

FIG. 3G shows an expanded view of a latch, spring, and shoulder bolts that allow for the latch to move in the z direction.

FIG. 3H shows a close-up view of a latch ball bearing entering a latch arm groove.

FIG. 3I shows an expanded angled view of components on a utility bracket (utility bracket 303, as described in embodiments herein).

FIG. 4A shows an isometric top view of module 3, which is the upper shell subassembly 5.

FIG. 4B shows a isometric bottom view of module 3 (the upper shell subassembly 5).

FIG. 4C shows a bottom view of a main board (main PCBA 890).

FIG. 4D shows an expanded isometric view of module 3 (the upper shell subassembly 5).

FIG. 5A shows a schematic of the structural loop and alignment interdependencies of the cartridge to the device.

FIG. 5B shows a bottom view of the gantry sub-assembly where the kinematic slots are symmetric.

FIG. 5C shows an isometric view of a heater, poron, and heater bracket, with integrated vee and flat alignment features.

FIG. 6 shows an embodiment of a device where the geometry of the base of the device is reduced towards the bottom, making the device easier to hold in the hand.

### DETAILED DESCRIPTION OF THE INVENTION

The drawings and embodiments of the invention described herein are provided by way of example, it being expressly understood that the description and drawings are only for the purpose of illustration and that the embodiments are not intended to define the limits of the present invention.

Described herein is a modular apparatus designed to receive and engage a microfluidic cartridge. The apparatus may contain components, such as, for example, a heater, useful for conducting certain tests of the fluid contained within the cartridge. The apparatus described herein may be used as a point-of-care medical diagnostics device.

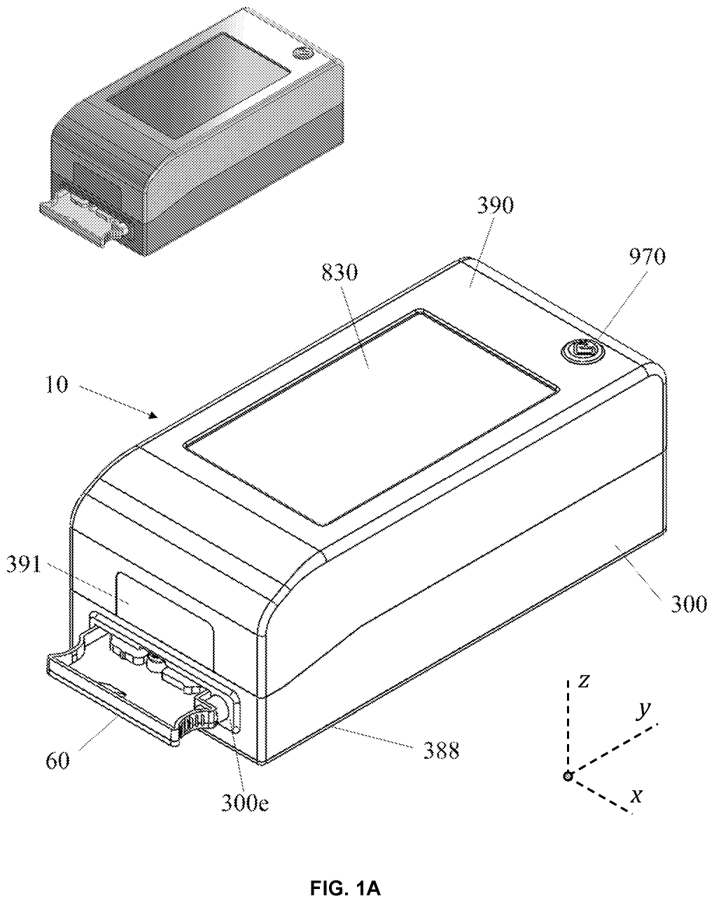

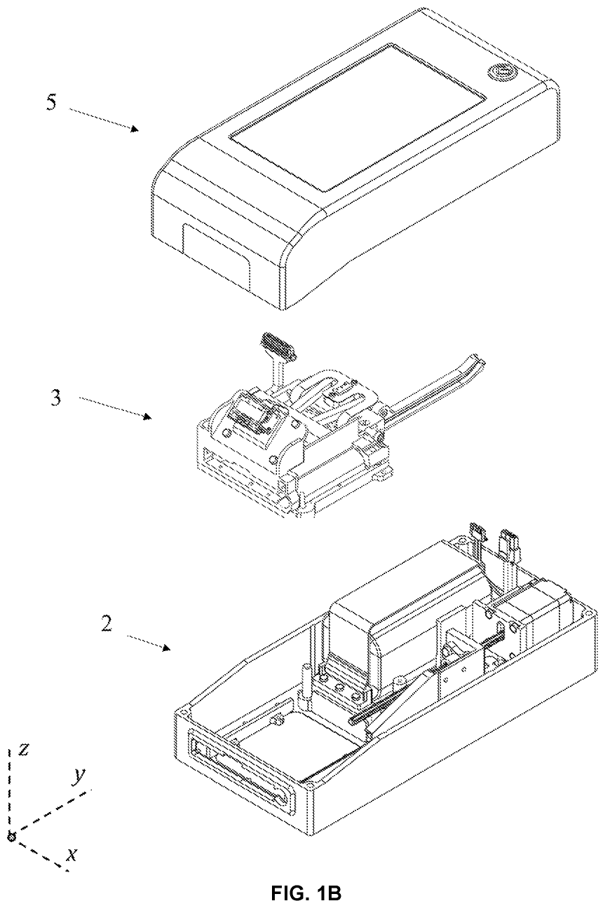

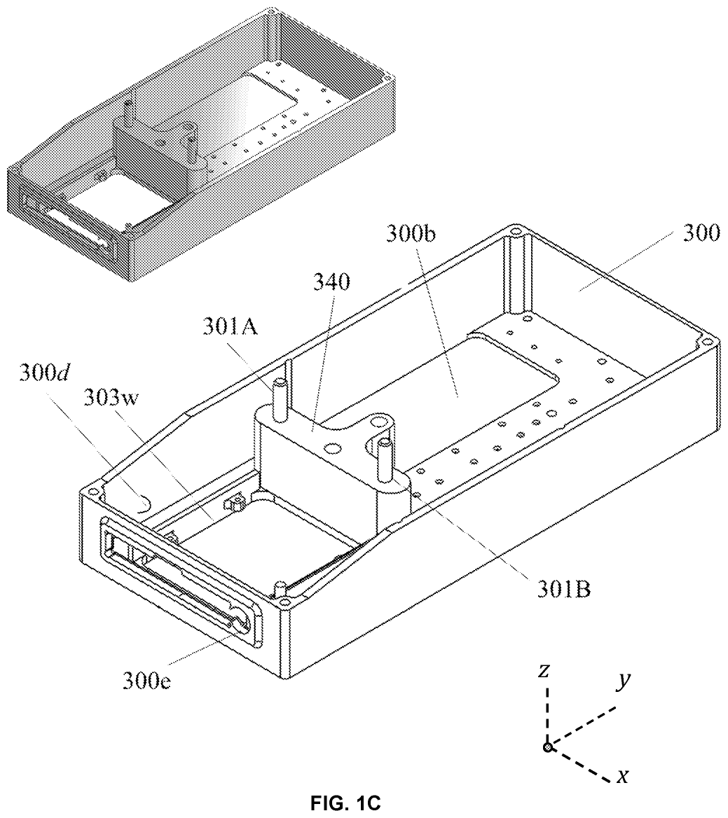

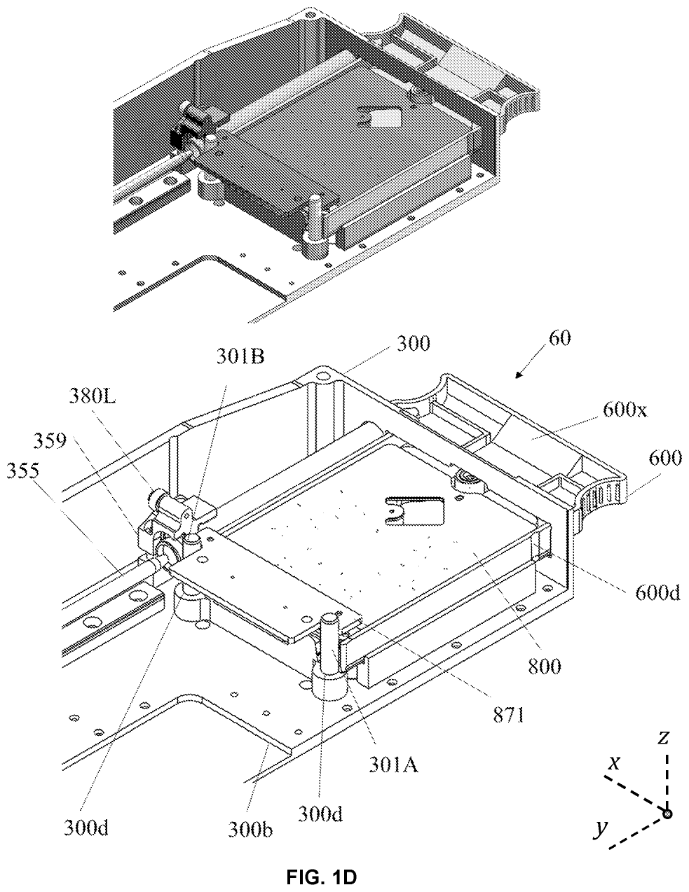

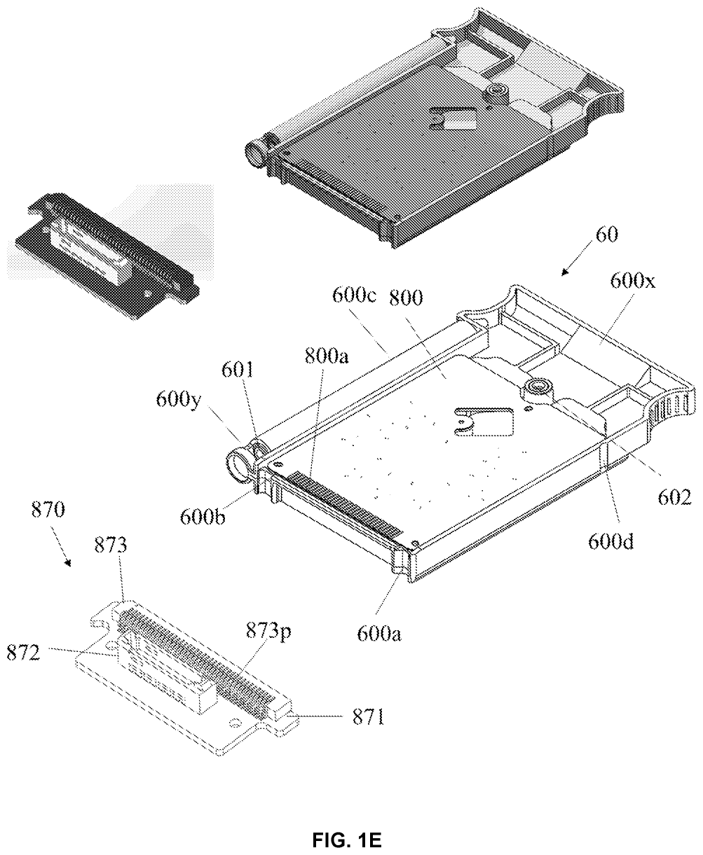

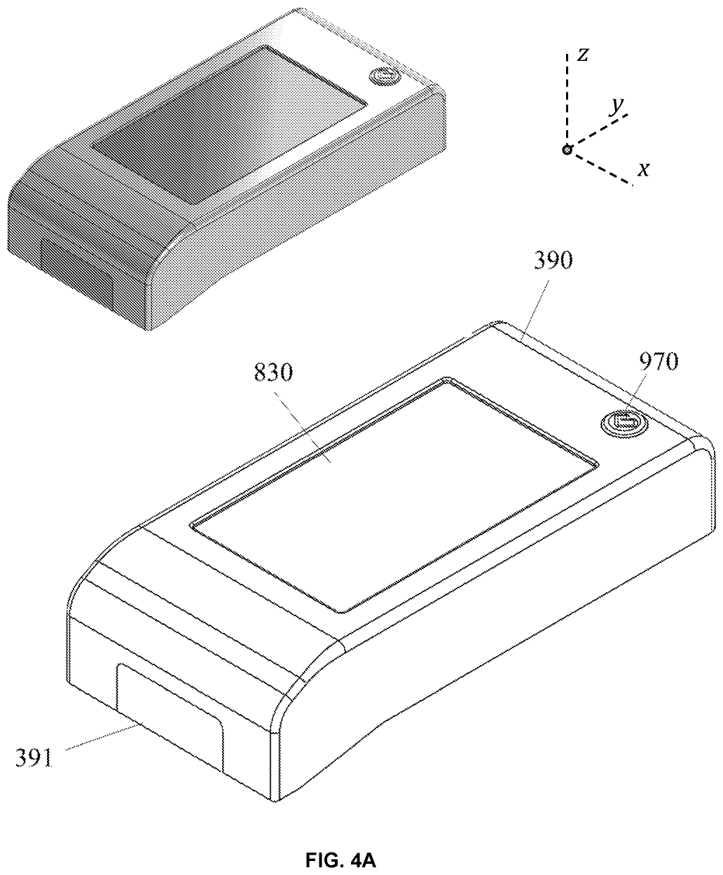

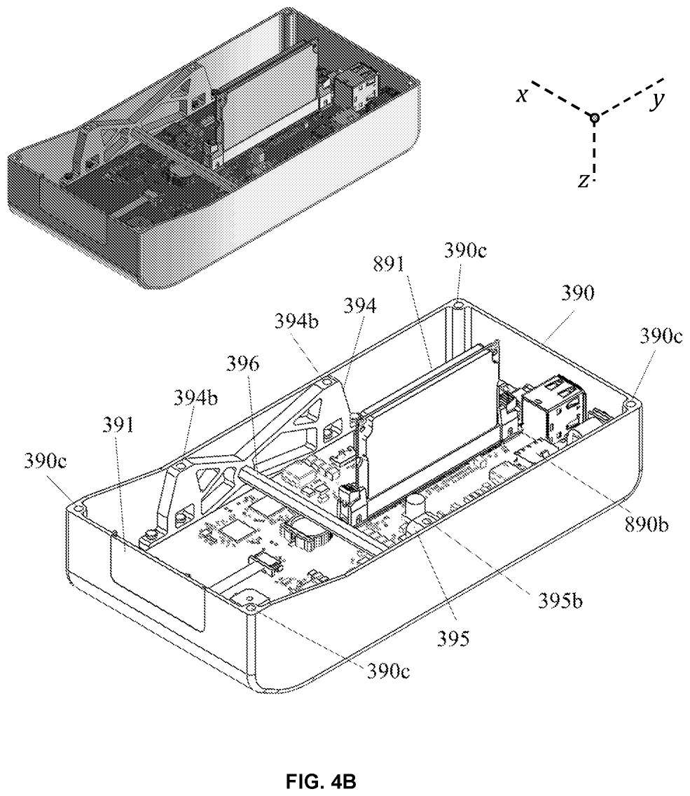

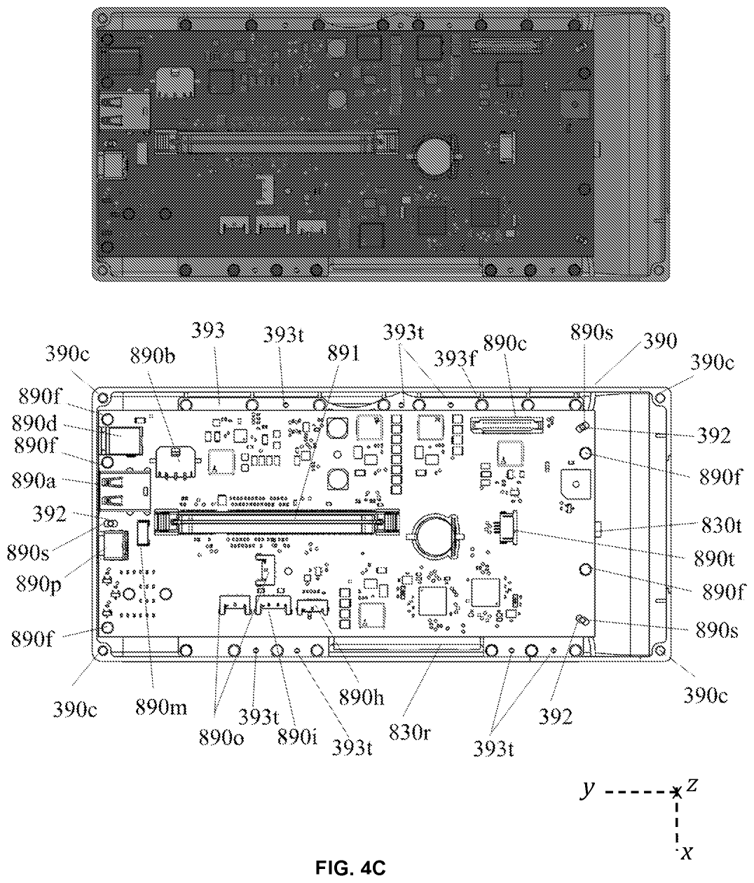

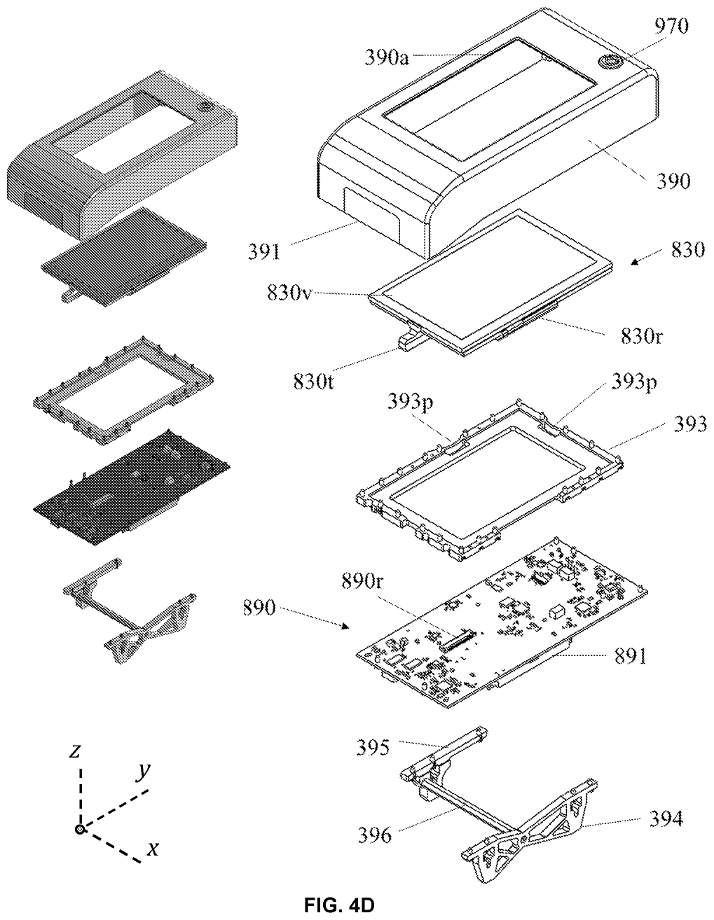

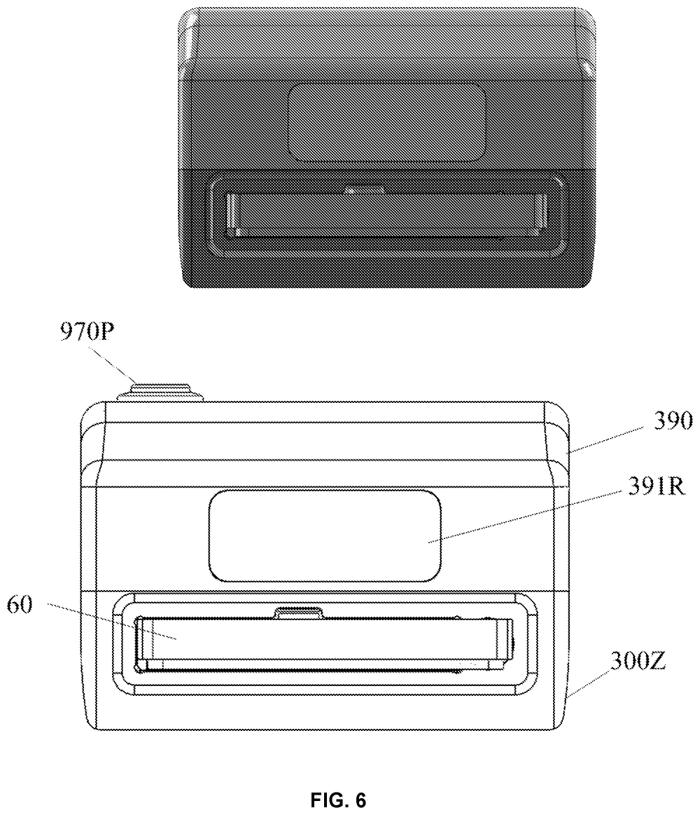

As shown in the embodiment depicted in FIG. 1A and FIG. 1B, the device 10 has an entrance 300e for accepting a cartridge 60 containing a fluid sample. In some embodiments, above the cartridge is window 391, which is transparent such that a barcode reader (if present) may read a barcode or label on the cartridge 60 as well as scan the badges of hospital personnel, for example. The bottom of the device may have an elastomer base 388 that prevents slipping, and that limits access to the fastener at the bottom of the base 300. The upper shell 390 of the device may have an open section 390a where the user can interact with a touch screen active region 830v with LCD touchscreen assembly 830. See FIG. 4A and FIG. 4D. The device 10 unit is turned on via a power button 970. The bottom base 300 may be shaped, as illustrated in the embodiment depicted in FIG. 6 (see 300Z in FIG. 6), to improve the ergonomics of the device and assist the user in holding the device in the hand. As described in more detail herein, the features of device 10 allow for precision in assembly and efficient manufacturing.

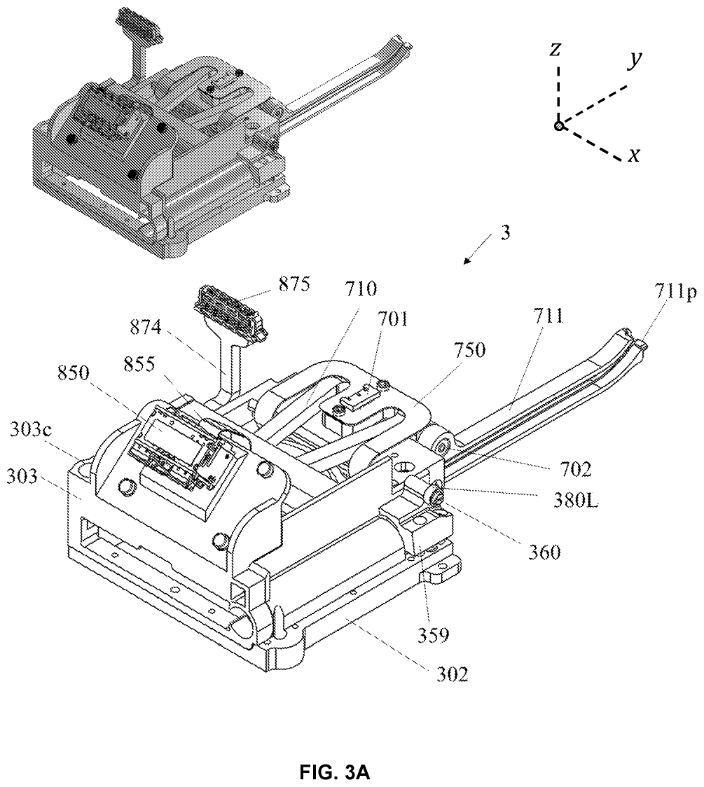

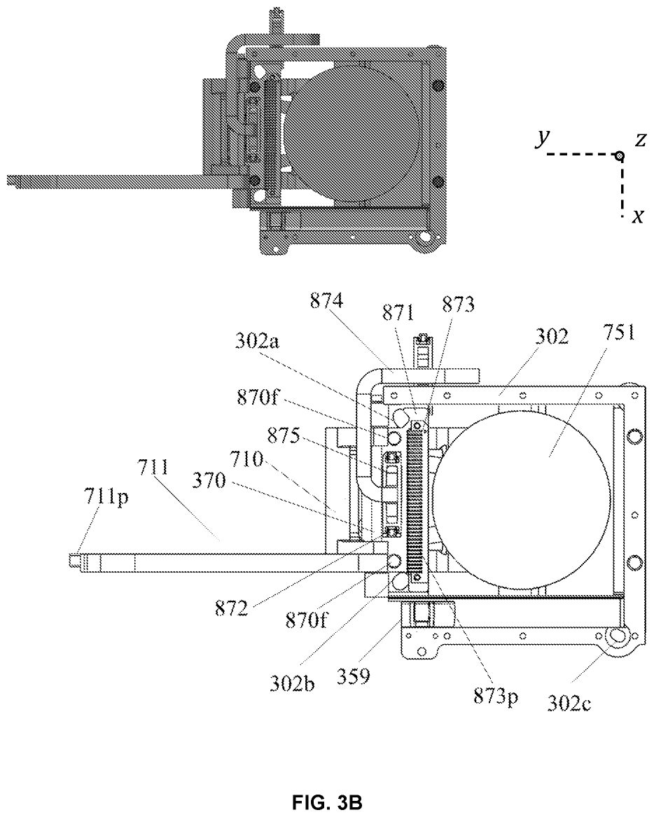

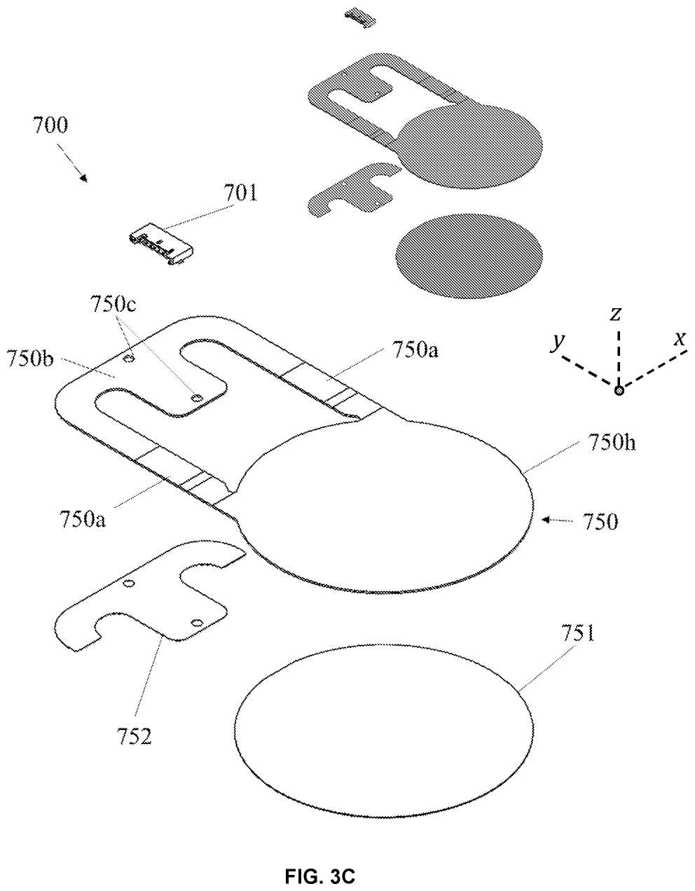

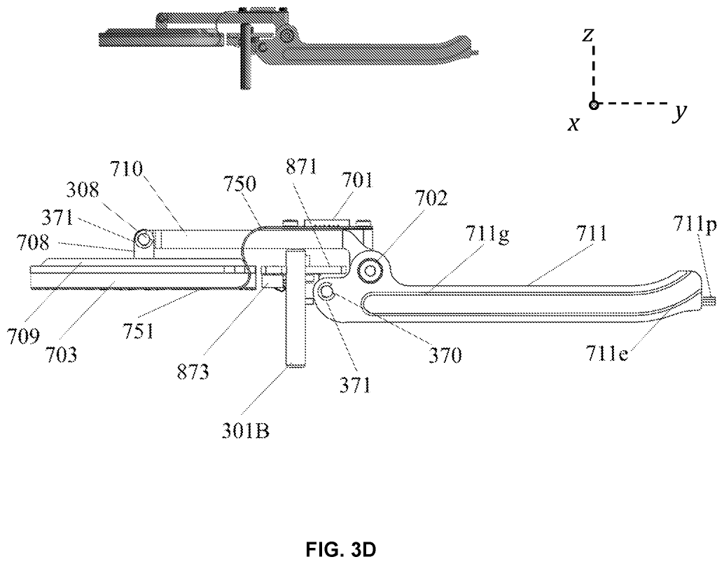

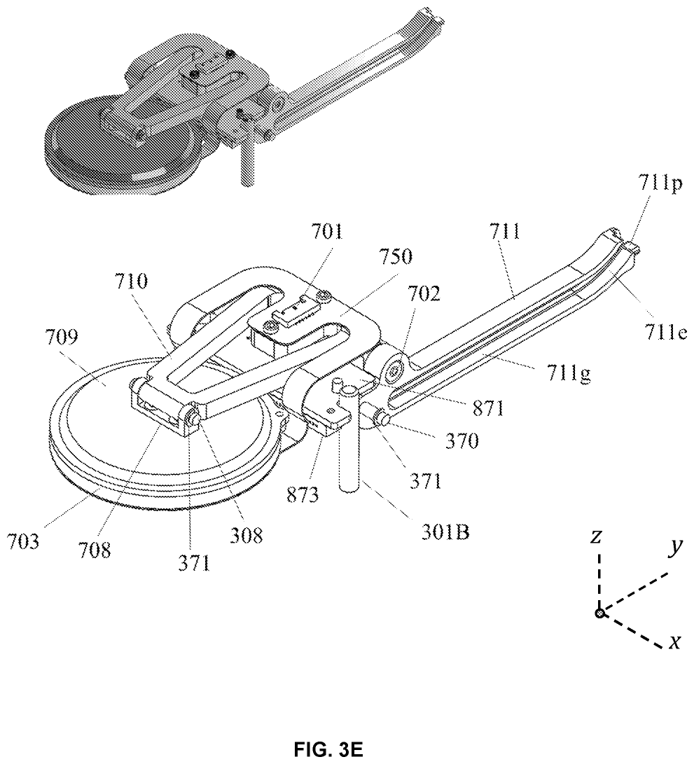

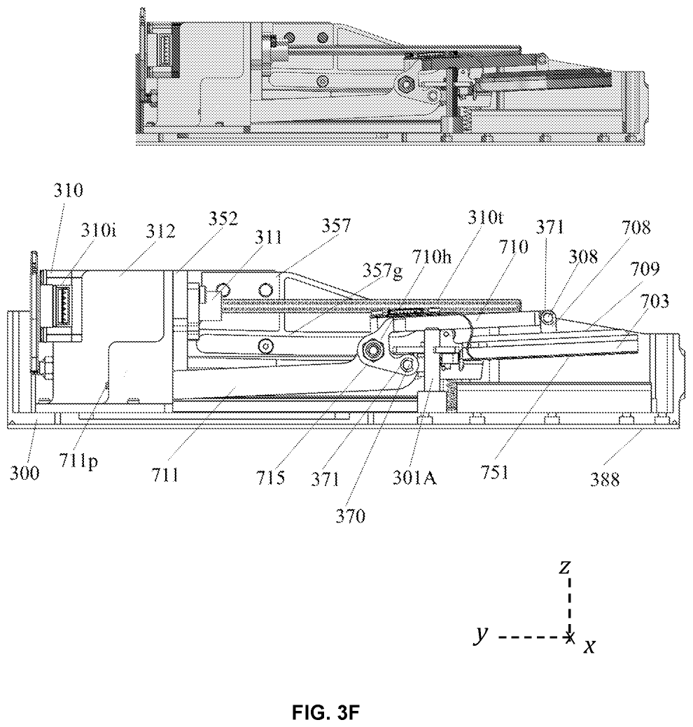

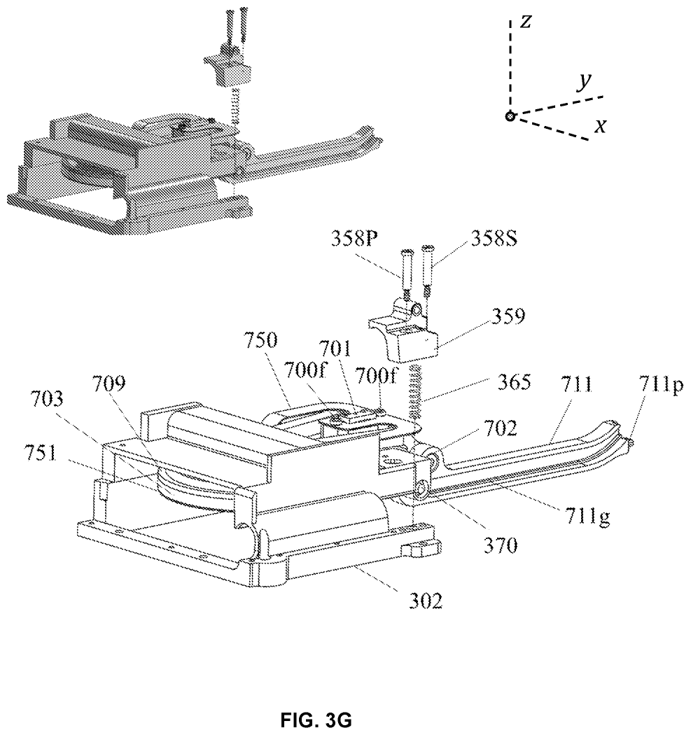

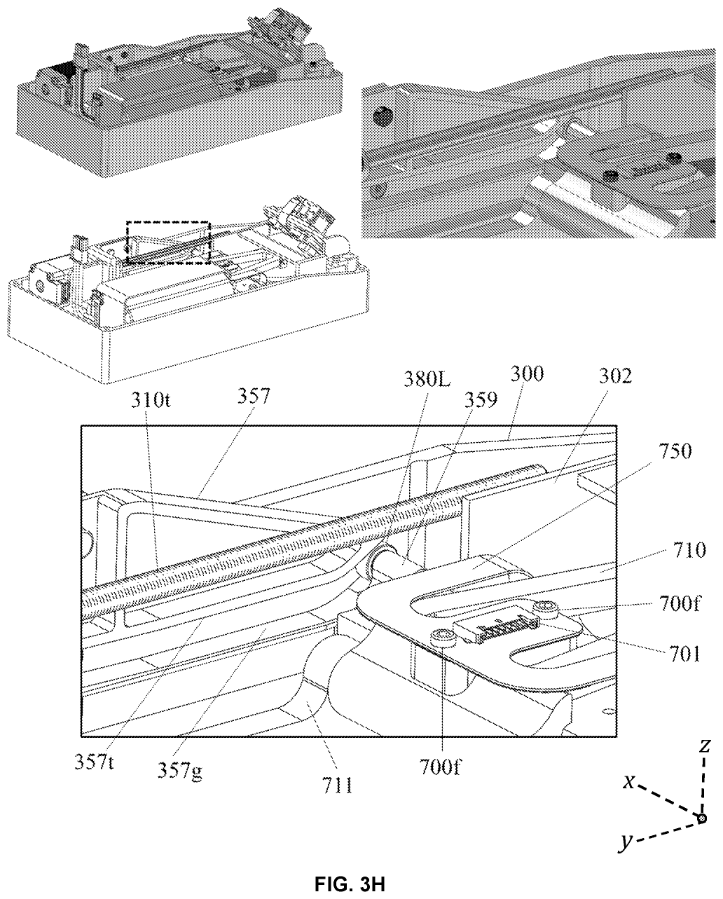

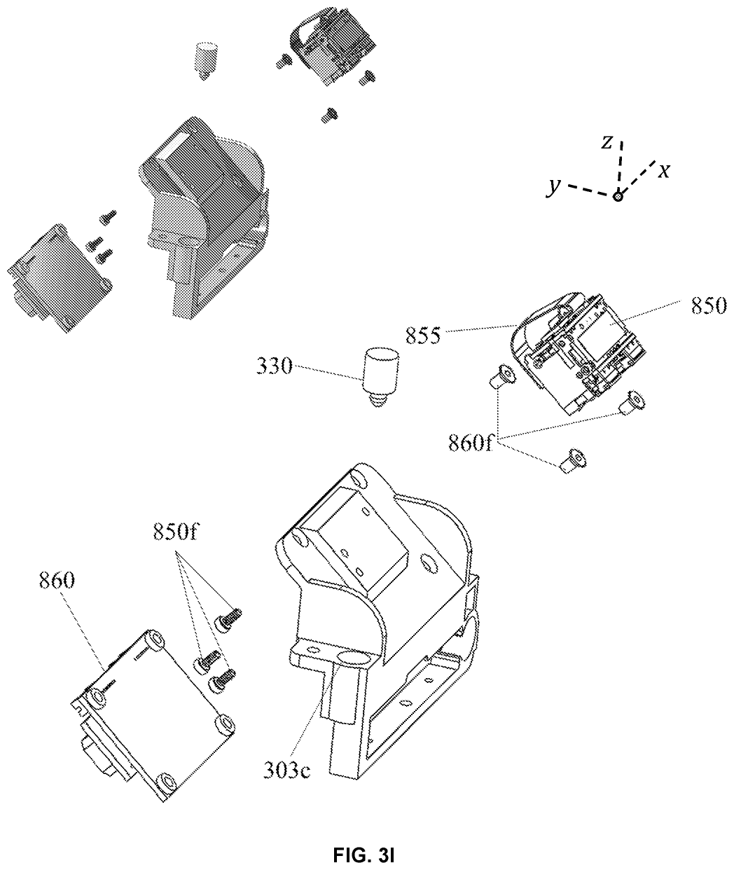

The configuration of the device 10 shown in the embodiment depicted in FIG. 1B is divided into three modules: module 1 is base subassembly 2; module 2 is gantry subassembly 3; and module 3 is upper shell subassembly 5. The first module (module 1) is a base subassembly 2 that uses the base 300 to establish the key datum for the device as well as hold a number of mechanical components. Module 2 is the internal gantry subassembly 3, which may comprise additional hardware such as a heater 700 (see FIG. 3C) to bring the fluid sample in the cartridge 60 up to a desired testing temperature, as well as other electronic components. Module 3 is the upper shell subassembly 5, which includes a power button 970, LCD touchscreen assembly 830, and primary circuit board 890.

Development of the device's design started with establishing a single key datum in the base subassembly 2 for aligning certain device components, and for aligning the interface or connection between the cartridge 60 and the device 10. Robust precision alignment can be achieved by maintaining a tight structural loop and referencing or aligning the device's critical components and the cartridge to one key datum. Such robust alignment minimizes the need for an intricate tolerance stackup analysis for aligning critical components. In the illustrated embodiments, the key datum 30 for the device 10 are two pins, shown as two dowel pins 301A and 301B, that are press fit into the base (e.g., monolithic base) 300, as shown in FIG. 1C. The two dowel pins 301A and 301B align the cartridge 60, gantry 302 (module 2) (see FIG. 3A), and interface board 870 (module 2) (see FIG. 1E).

In preferred embodiments, the alignment of the pins (e.g., two dowel pins 301A and 301B) is within 0.5 degrees from orthogonal. In embodiments where pins are press fit into a base, a high-precision arbor press may be used as part of the assembly process. Example arbor presses that may be used include the Schmidt Precision Manual toggle press D78112.

As shown in FIG. 1C, a fixture 340 can be used to align dowel pins 301A and 301B to the datum dowel pin holes 300d on the base (e.g., monolithic base) 300. The base 300 may be made from MIC 6 or from 6061 T651 aluminum, if it is made from an off-the-shelf stock material. In embodiments where the base is made of aluminum, the aluminum may conduct any operational heat generated from the battery 930, stepper motor 310, and other electronic components to the environment. Fixture plate or cast aluminum is preferred for the geometry of the base to be maintained throughout the machining process. Magnesium die casting aluminum, with post machining to generate the final geometry, is another option.

FIG. 1D shows a cartridge 60 with a barcode region 600x on the cartridge body 600. The cartridge body 600 aligns to the pins, 301A and 301B, at locations 600a and 600b, respectively (see FIG. 1E). The base 300 embodiment illustrated in FIG. 1D has a latch 359 mounted to the base 300. The latch 359 locks the cartridge 60 in place while the stinger (or push rod) 355 pushes on a bung 601 that is inside the cartridge cylindrical region 600c (see FIG. 1E). In this example, the fluid sample is inserted into the cartridge via a septum 602, as shown in FIG. 1E. The pushing of the bung 601 activates the fluidics in the cartridge 60. The cartridge 60 is prevented from moving by the latch 359 that engages a groove 600y on the cartridge body 600. The interface board assembly 870 aligns to the same two pins 301A and 301B. FIG. 1E shows a cartridge 60 with a pcb board 800 that has a series of contact pads 800a at the leading edge. The contact pads 800a make electrical contact with the Samtec spring connector 873p. The interface board pcb 871 contains the routing lines to the tigereye connector 872 that eventually connects to the main PCBA board 890 that can process data.

### Base Subassembly

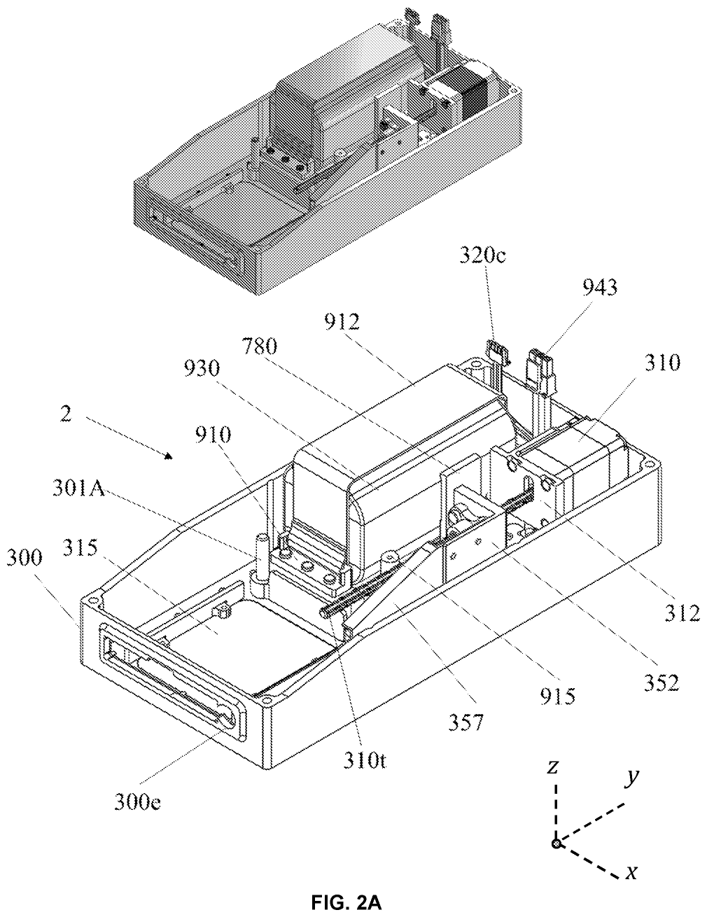

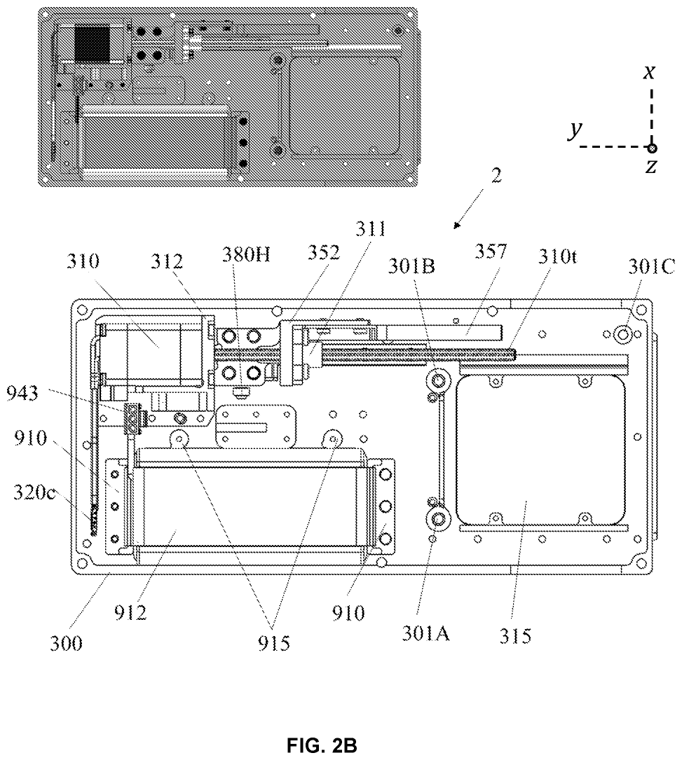

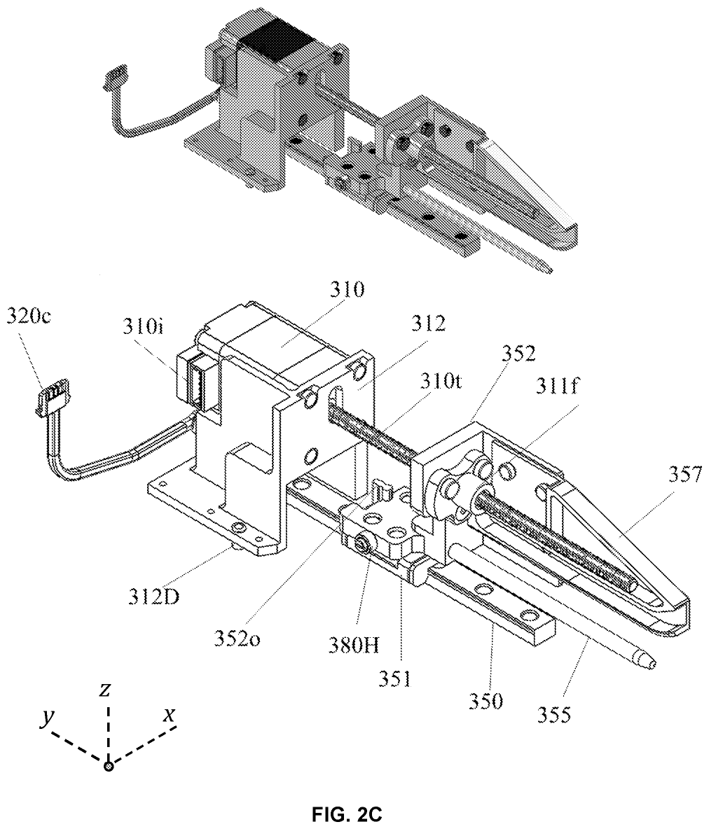

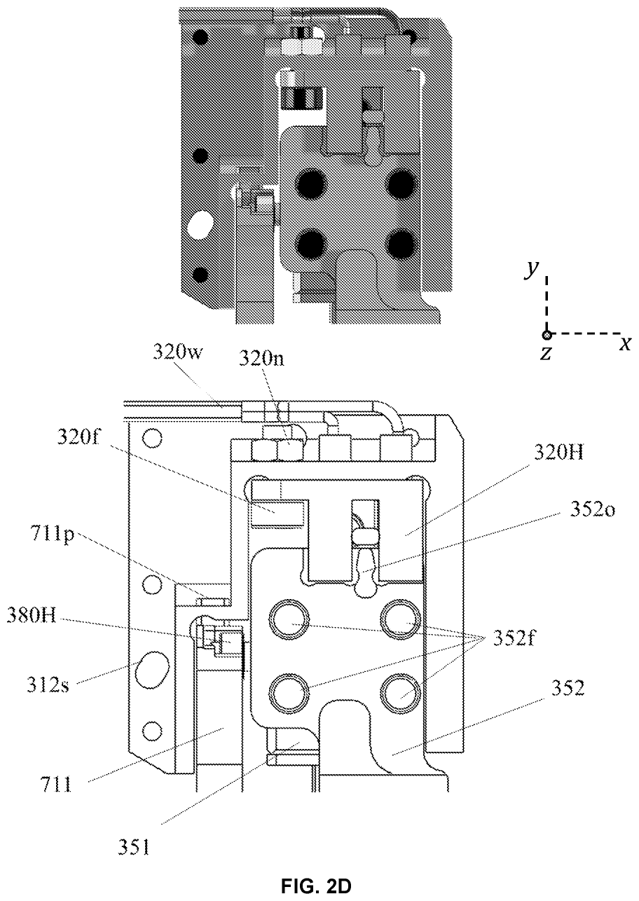

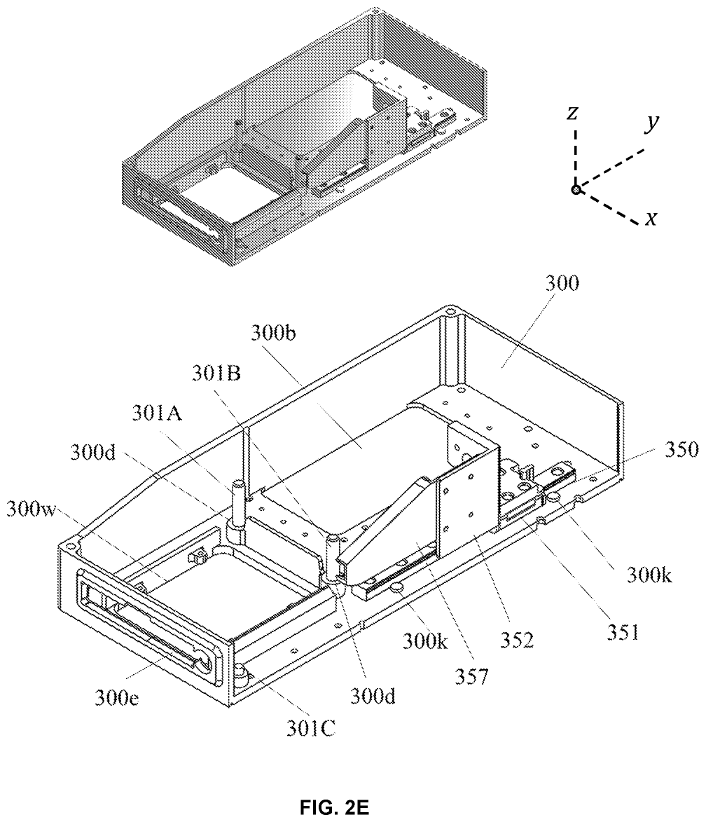

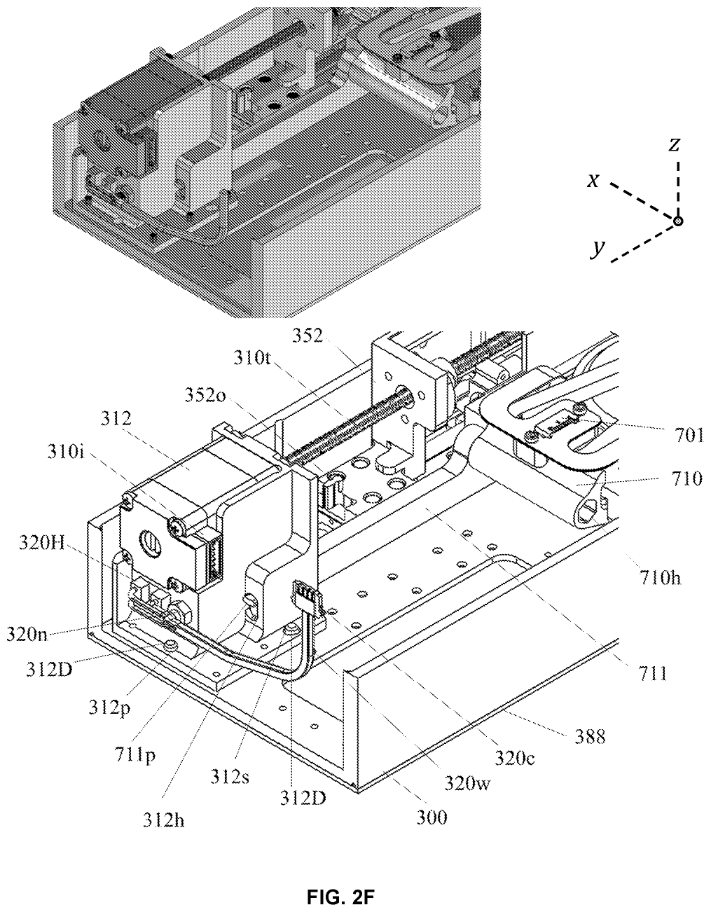

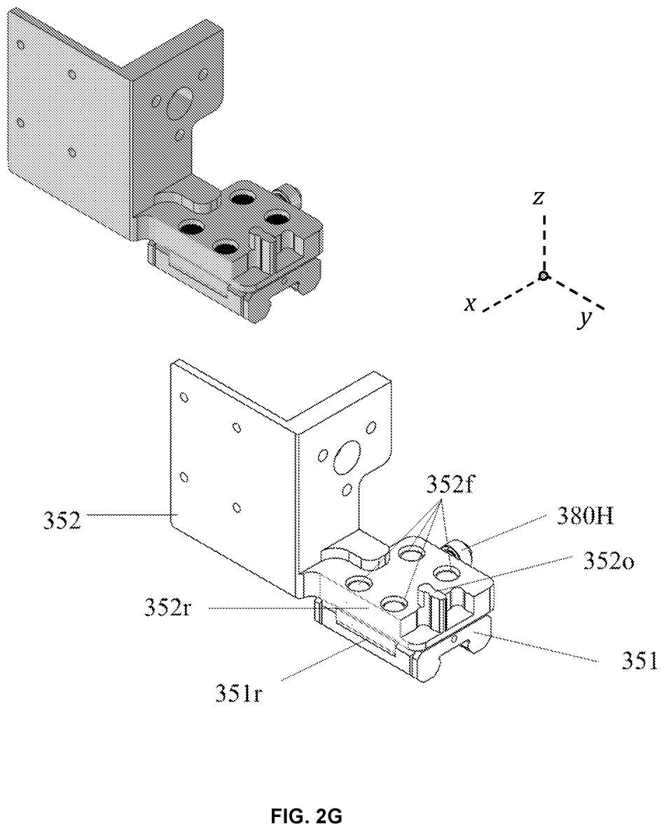

In addition to establishing the alignment datum, the base 300 (which may be a monolithic base) also serves to mount the other base subassembly 2 components such as: a battery 930, linear actuator 310, linear guide rail 350, carriage 351, and other associated components, as partially shown in FIG. 2A and FIG. 2B.

In some embodiments, the base 300 has a window aperture 300w underneath the cartridge fluidics region that allows for visual inspection during the assembly process. The window aperture 300w is closed with a lid 315 (see FIGS. 2A, 2B, and 2E). A bracket 780 can be used to engage the toradex processing chip 891 (see FIG. 4B) and direct the heat generated to the base 300.

In certain embodiments, the device (e.g., in the base subassembly) may include a flexible detent engaging feature, shown as 300d in FIG. 1C, such as a spring plunger that engages with a detent in cartridge 60 (detent shown as 600d in FIG. 1D and FIG. 1E). Such a flexible detent engaging feature can provide the user with tactile feedback that the cartridge is fully engaged.

### Base Subassembly: Battery

The device 10 may be designed to be powered from a wall outlet via an AC to DC power adapter (similar to laptop computers), and/or to be portable and powered with a DC battery 930 enclosed inside the device 10. In embodiments where the device may house a battery, the base 300 may have a recess pocket 300b (as shown in FIG. 1C) for the battery 930. For safety reasons, it may be desirable to have all of the electronic components inside the device to be DC powered. As shown in FIG. 2A and FIG. 4B, the battery 930 has wires with connector 943 that mates with the main PCBA 890 at location 890b. The base 300 can secure the battery 930 via an elastic strap 912, which also can be used to preload the battery 930 to the base 300. Two brackets 910 may be used to secure the elastic strap 912 to the base 300. Two CAM posts 915 may be used to further constrain the battery 930. There are several other ways to secure and preload the battery 930 to the base 300; for example, a rigid bracket with a foam interface may be used to preload the battery.

### Base Subassembly: Linear Actuator

The device 10 may contain at least one actuator whose primary function is to engage a mechanism that actuates the fluidics of the cartridge 60.

Increasing the number of actuators will increase production cost. The embodiments described herein illustrate how a single actuator can be used for the desired function(s) of the device 10. The base subassembly 2 embodiment illustrated in FIG. 2A shows a stepper motor 310 as the actuator. Such an actuator may be used to carry out several tasks, including, for example, lowering the heater 700, securing the cartridge 60 in place within the device (e.g., by latching/locking the cartridge 60), and/or pushing on a bung inside the cartridge 60 to activate the fluidics in the cartridge 60. In embodiments described herein, a cable connects the motor interface 310i (see FIG. 2C) to the connection 890r on the main PCBA 890 (see FIG. 4D).

For some embodiments, a heater 700 may be required to conduct specific tests. For example, coagulation testing may require that the samples be heated to approximately 37° C. A mechanical lever mechanism, such as the stepper motor 310 shown in the embodiment depicted in FIG. 2A, may be used to bring a heater 700 into contact with the cartridge 60. In addition to performing this function of lowering a heater, a mechanical lever mechanism, such as the stepper motor 310, may also secure the cartridge 60 to the device 10. The third task, pushing a bung in the cartridge 60 to trigger the movement of fluid in the cartridge 60, may also be activated via the stepper motor 310 by moving a push rod (also known as a piston rod or stinger) 355 in the negative y direction.

In the embodiment described above, the latching mechanism (used to secure the cartridge 60 in place, within the device) is incorporated into base subassembly 2. In other embodiments, a latching mechanism can be incorporated the gantry subassembly 3.

### Base Subassembly: Linear Guide Rail and Carriage

The use of a single stepper motor 310 to perform the three tasks discussed above can be accomplished by using a linear guide rail 350 and carriage 351, in conjunction with a multifunction bracket 352 that is driven by the stepper motor 310, as shown in FIG. 2C. A motor mount 312 can be used to mount the stepper motor 310 to the base 300. A linear guide rail 350 may be configured to be parallel to a motor leadscrew 310t, with a low-profile carriage 351. As shown in this embodiment, the multifunction bracket 352 mounted on the carriage 351 (via four fasteners 352f, see FIG. 2D) also holds the stepper motor nut 311; thus, as the leadscrew 310t rotates, the linear carriage 351 moves in either the positive y direction or in the negative y direction.

As shown in FIG. 2B and FIG. 2C, the carriage bracket 352 may be used to mount several components, such as: a heater actuation arm ball bearing 380H, a nut 311, a latch guide rail 357, and a push rod 355. The carriage bracket 352 also has a flag region 352o that engages a photo interrupt 320H, mounted on the motor mount 312 with an M3 fastener 320f and locking nut 320n (see FIG. 2D). The photo interrupt 320H serves to home or guide the motor 310 during the startup procedure. The photo interrupt wires 320w, with connector 320c, connect to the main carrier PCBA 890 at location 8900 (see FIG. 2C and FIG. 4C). As the motor lead screw 310t rotates, the nut 311 travels along the length of the leadscrew 310t and the bracket 352 moves towards or away from the motor mount 312. As shown in FIG. 2D, the flag 352o on the bracket 352 serves to break a photo interrupt 320H beam, thus “homing” the motor 310. A secondary photo interrupt 320 may be mounted on the gantry utility bracket 303 where the latch actuator 357 may have a flag to trigger the photo interrupt. The purpose of an optional second photo interrupt 320 is as a redundant safety.

### Base Subassembly: Alignment Features

As shown in FIG. 2E, the bearing rail 350 can be placed against two projections 300k (e.g., dowel pins) or a reference edge, at the same time pins 301A and 301B are precisely placed with respect to the base 300. In this way, alignment is achieved between the axis of motion that guides the push rod 355 and the cartridge cylinder chamber, as the cartridge 60 is kinematically aligned by the two pins 301A and 301B contacting a vee and a flat on the cartridge 60, as shown FIG. 1D. Closing the structural loop locally on the cartridge 60 at the cylinder bore entrance by latch arm 357 moving in the negative Y direction, latch 359 (see FIG. 1D) engages a mating feature on the cartridge 60, ensuring that restraint is achieved, with the center of stiffness (the latch) and friction (the sliding seal in the cartridge cylinder bore created by the push rod 355) being very close together to reduce movements that may otherwise cause misalignment. Maintaining alignment of the components in turn maintains the electrical contacts between the cartridge 60 and the device 10, even when high injection forces are generated by, e.g., the push rod 355 pushing the bung 601 in the cartridge 60 to activate movement of fluid in the cartridge 60.

In some embodiments, the motor mount 312 is aligned to the base 300 via two dowel pins 312D; one dowel pin is placed into a hole 312p and the other dowel pin is placed into a slot 312s to ensure that the components are not over constrained, as shown in FIG. 2F. The carriage bracket 352 can be aligned to the carriage 351 by matching reference surface 352r on the carriage bracket 352, to the reference flat surface 351r on the carriage 351, as shown in FIG. 2G. There are alternative ways for aligning the carriage bracket 352 to other device components; such alternatives include the use of parallels and/or fixtures.

### Gantry Subassembly

Module 2 of the device 10 is the gantry subassembly 3, as shown in FIG. 3A and FIG. 3B. The gantry 302 may hold equipment used for engaging the cartridge 60. The illustrated embodiment shows several components mounted on the gantry 302; such components include a heating element 700 (see FIG. 3C), a latch 359 with associated mechanism to secure the cartridge in place, a barcode reader 850 with associated equipment, and a means to generate a click when the cartridge 60 is fully inserted.

FIG. 3B illustrates a bottom view of the gantry subassembly 3 and shows an interface board assembly 870 that in turn contains an interface board pcb 871, tigereye 872, and spring connector 873 (see also FIG. 1E). Interface board 870 aligns to the pins 301A and 301B via a vee and flat geometry on the interface board pcb 871. The interface board 870 is secured (after alignment to the two dowel pins 301A and 301B) to the gantry 302 using two fasteners 870f. The spring connector 873 shown in this embodiment is a 40 pin connector made by Samtec. The connector spring pins 873p engage the cartridge pads 800a as shown in FIG. 1E. The bottom view also shows the three slots 302a, 302b, and 302c, which serve to kinematically align the gantry to the dowel pins 301A, 301B, and 301C, respectively (see FIG. 2E). The benefits of the kinematic alignment are discussed further herein. A cable connects at tigereye interface 872 with a connector 875. The wire 874 leads to a second connector 875 that connects to the main PCBA 890 at location 890c.

### Gantry Subassembly: Heating Element

FIG. 3C shows an expanded view of a heater 700 that can make contact with the cartridge 60.

The heater 700 may comprise a heating element 750, as shown in FIG. 3C. The heating element 750 may be made of multiple materials, including but not limited to polyimide, copper, and/or CuNi; each such material may be a layer bonded to another layer with an adhesive, creating a sandwich of multiple layers, for example. A stainless-steel laminate 751 can be used to minimize wear on the heating element 750.

The heater 700 may include components for measuring temperature, such as thermistors (not shown), which can be mounted on the top of heating element 750, to monitor the temperature of the system.

The embodiment depicted in FIG. 3C shows a split design, where the heating element 750 is separated into at least three regions: a heating section 750h, two flexible arms 750a, and a base region 750b. The heater region 750h serves to heat a section of the cartridge 60. The base region 750b can be used to mount a connector 701 for monitoring and activating the heater 700. The heater 700 is mounted to a heater arm 710 (via two fasteners 700f) at the base region 750b, which has two clearance holes 750c. The two arms 750a may be flexible and may isolate heating section 750h from the base region 750b. A cable can be used to link the connector 701 to the PCBA board 890 at connection 890h. The connector 701 may involve positive engagement and/or comprise a clicking connector, to pass vibration and drop testing. In some embodiments, the cable is strain-relieved to prevent vibration during handling. Underneath the connector region, a second support plate 752 may be included to ensure that the bending of the heating element 750 is constrained to the arms 750a.

### Gantry Subassembly: Heater Mechanism

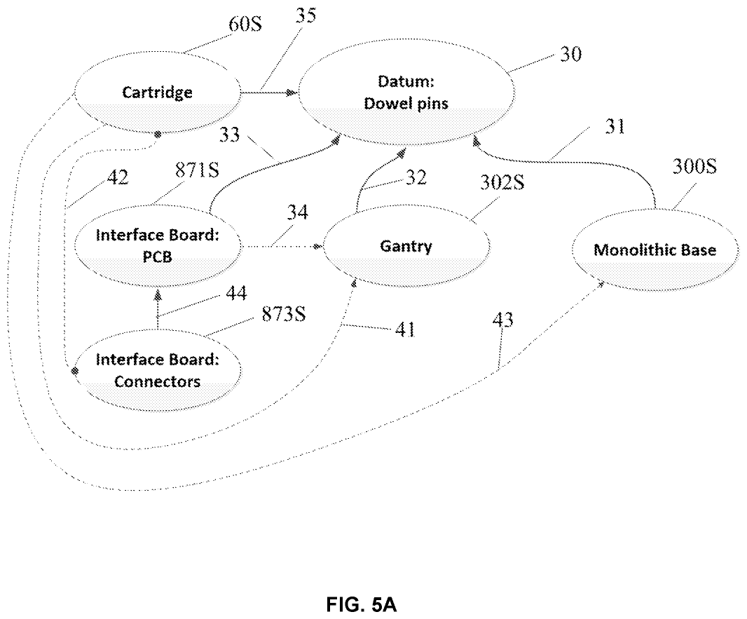

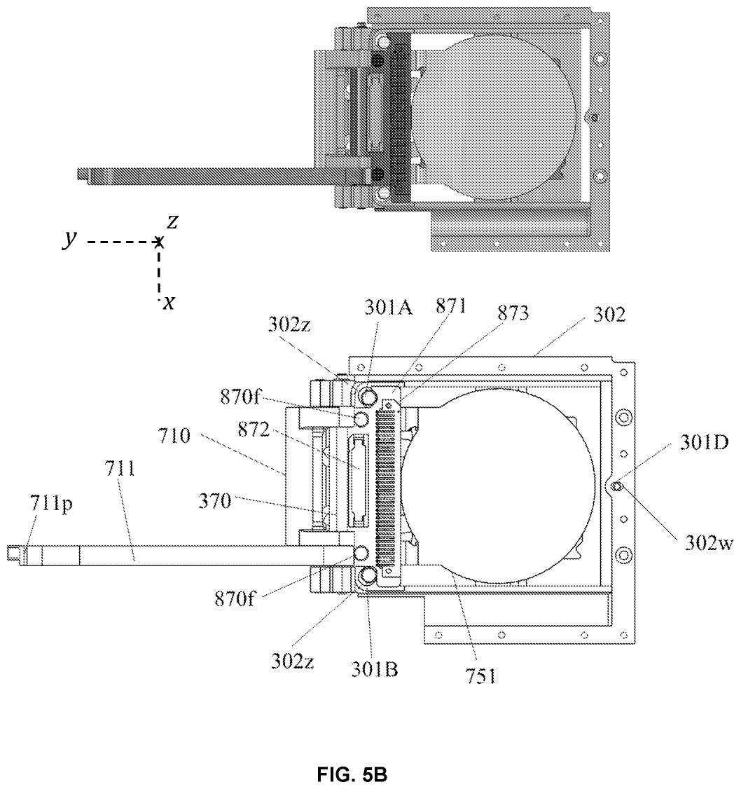

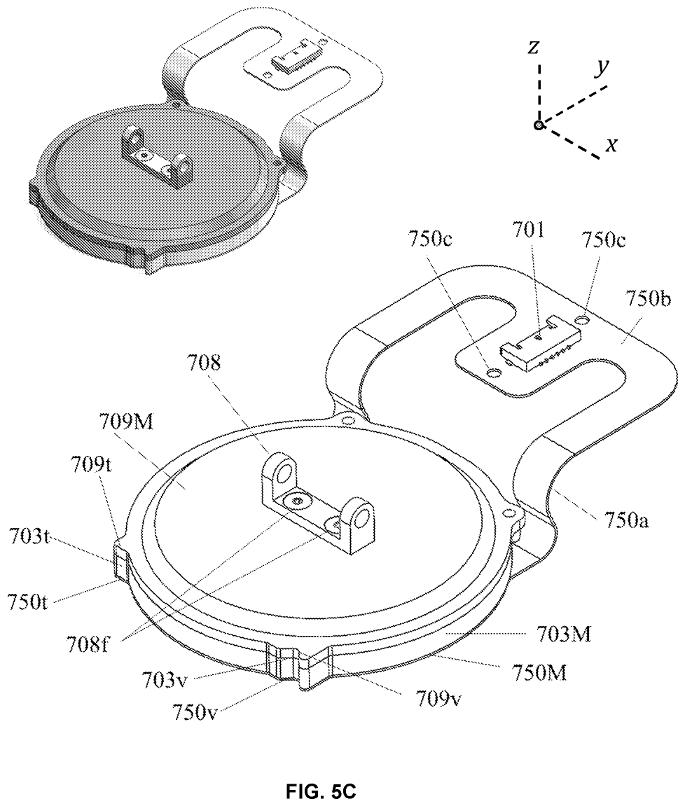

As shown in FIG. 3D and FIG. 3E, the heater mechanism may include several parts. The heater 700 may be secured to a disk 709 with a conforming layer 703 (for example, foam, such as Poron foam) in between the components. In certain embodiments, the heater disk 709 has a u-shaped bracket 708 that allows the heater disk 709 to be mounted onto the heater arm 710 using two fasteners 708f (fasteners 708f are shown in the embodiment depicted in FIG. 5C). The heater disk 709 can rotate in the x axis relative the heater arm 710 via a pin 308, secured via e-clips 371 (e.g., with an e-clip near each end of the pin). The heater arm 710 is mounted on the gantry 302, via a longer pin 370, also secured via e-clips 371. The pin 370 serves as the rotation axis of the entire heater arm 710. The heater lever 711 is also allowed to pivot about pin 370. The rotation of the heater lever 711 is locked to the heater arm 710 due to a shoulder bolt 702 that transfers forces between the two components. A nut 715 fits inside a hexagonal pocket 710h of the heater arm 710 (see FIG. 3F) so that the shoulder bolt 702 mates the heater arm 710 to the heater lever 711. The heater lever 711 has a groove 711g with a non-linear shape that serves as a track channel for, e.g., ball bearing 380H (see FIG. 2C), or a roller such as a sleeve bearing on a post such as a shoulder screw. When the ball bearing 380H is in the groove entry region 711e, the heater unit is said to be in its raised configuration, which occurs when the carriage bracket 352 is closest to the motor mount 312 (home position), see FIG. 3F (several structural components are hidden in FIG. 3F to illustrate the tilting of the heater). As the motor 310 rotates in the forward direction, the nut 311 moves in the negative y direction, which thereby also moves the carriage bracket 352, as three fasteners (311f, 311c, as shown in FIG. 2C) secure the nut 311 to the carriage bracket 352. The ball bearing 380H on the carriage bracket 352 rolls along in the groove 711g. The primary rotation of the heater mechanism occurs when the ball bearing 380H travels along the groove entry region 711e. The heater lever 711 has a post 711p that loosely fits in a slot 312h (see FIG. 2F) so that in the event of a drop test or vibrations, the heater lever 711 has some constraint to prevent overstressing.

Embodiments without a heater are also within the scope of the present invention. For example, in certain embodiments, a microfluidic cartridge may contain an internal heating element, and a device configured to receive such microfluidic cartridge does not contain a heater. In some such embodiments, the device may comprise a controller for activating and controlling the heating element of the microfluidic cartridge.

### Gantry Subassembly: Latch

As shown in the embodiment depicted in FIG. 3G, the latch 359 can be mounted on the gantry 302 via two shoulder bolts 358P and 358S. A compression spring 365 may be partially held in a pocket in the gantry 302 and partially held in a pocket in the latch 359. In some embodiments, the spring 365 is sized to have a preload of less than 2 newtons but more than 0.5 newtons. In other embodiments, the latch 359 is mounted to the base 300.

FIG. 3H also shows the latch 359. Latch 359 is the second component that is actuated by linear actuator 310 (which, as discussed above, may be a stepper motor in some embodiments). In certain embodiments, a ball bearing 380L is mounted on the latch 359 using a shoulder bolt 360 (shoulder bolt 360 is shown in FIG. 3A). Using a ball bearing 380L allows for a rolling motion with the latch actuation arm 357, which in turn increases the life of the product compared to embodiments employing rubbing surfaces, which tend to wear and lead to premature failures. The z motion of the latch takes place when the ball bearing 380L moves along the latch arm groove 357g. When the cartridge begins to engage, the ball bearing 380L rides the top of the groove 357t.

### Gantry Subassembly: Barcode

In some embodiments, such as in the point-of-care setting or other hospital or healthcare-provider setting, it may be desirable to have a barcode reader that can read codes outside of the device, as well as read codes on the cartridge. Accordingly, for some embodiments, a barcode reader 850 may be placed at a tilted angle inside the device 10, and a clear window 391 on the upper shell 390 can allow for scanning a barcode on the cartridge 60, as well as scanning any other barcode (i.e., for the purpose of acquiring or tracking patient information, technician ID, etc.). See FIG. 4A. The window 391 can vary in shape and geometry, as shown by window 391R in the embodiment depicted in FIG. 6.

In the embodiment depicted in FIG. 3I, a barcode reader 850 is mounted on a gantry utility bracket 303 via three fasteners 850f. In other embodiments, a barcode reader 850 is not mounted on a gantry utility bracket; for example, in some embodiments, a barcode reader 850 may be mounted on the upper shell.

There are several possible configurations for barcode readers. In the embodiment illustrated in FIG. 3I, the barcode reader 850 and barcode electronics board 860 are separate components and connect to each other via a ribbon cable 855. The barcode electronics board 860 is mounted to the utility bracket 303 via fasteners 860f (three of the four fasteners 860f are shown in FIG. 3I). A cable connects the barcode electronics board 860 to the main PCBA 890 at connection 890i. A flat region on the cartridge 60 can be tilted such that the barcode reader 850 reads a barcode on the cartridge when the cartridge is in the engaged position. The configuration shown involves a flat window and a tilted viewing plane; however in some embodiments, it may be desirable to have window 391 be parallel to the viewing plane (the flat region on the cartridge).

The utility bracket 303 in this embodiment also serves to hold (via a reamed hole 303c) a sealed spring-loaded guide pin 330 (referred to herein as a “clicker”), which may serve at least two functions: to generate a clicking sound when the cartridge is fully inserted, and to provide the user mechanical feedback that the cartridge 60 is engaged. Depending on the tolerances of several components and features (such as the latch), the clicker 330 may also provide a counterforce to the forces applied by the rod pushing the bung in the cartridge 60. There are other means to accomplish the same clicking function to provide the user with tactile and/or auditory feedback.

### Upper Shell Subassembly

Module 3 of the device 10 is the upper shell subassembly 5, as shown in the embodiments depicted in FIGS. 4A-4D.

In some embodiments, an upper shell 390 comprises an LCD touchscreen assembly 830, where a user can enter information and interact with the device 10. A power button 970 allows for the device 10 to be turned on and off. The power button can be an off-the-shelf component 970P, or it can be a custom interface that allows for the main PCBA 890 to be turned on and off. A window 391 can be made from various transparent materials, including cell-cast plastic, optical glass with anti-reflective coating, etc.

FIG. 4B shows a bottom view of the upper shell subassembly 5. This bottom view shows the computer main PCBA board 890, processing module 891, structural support brackets 394 and 395, and a cross bar 396. The cross bar 396 between the brackets serves to mitigate crushing of the shell around the mid-section of the device 10. The two support brackets, 394 and 395, have holes with threads (394b and 395b) that serve to close the upper shell 390 to the base 300 in the mid-section via long fasteners 390f. In addition, there are four holes with threads 390C at the corners of the upper shell 390; these four threaded holes 390C serve to secure the corners. The PCBA board 890 aligns to the upper shell 390 using three slots 890s on the PCBA 890 and dowel pins 392 on the upper shell 390 (see FIG. 4C).

The main PCBA 890 with the processing unit 891 (see FIG. 4C) functions as a computer system with connectors for the following (bolded numbers refer to the connectors): dc power 890d, cartridge 890c, touchscreen 890t, heater 890h, barcode 890i, limit switches 890o, actuator 890m, battery 890b, usb-c 890p, usb-a 890a, and LCD screen 890r. Additional sensors and/or ports can be included in the main PCBA 890 to allow for additional functions of the device.

As shown in the embodiment depicted in FIG. 4D, the LCD touchscreen assembly 830 can be secured to the upper shell 390 via a bracket 393 that kinematically aligns the touchscreen against three posts on the upper shell 390 and provides a preload using two curved sections 393p. To accommodate the rigidity of the LCD touchscreen assembly 830, the bracket 393 is secured to the upper shell 390 with more than a dozen fasteners 393f. In addition, the bracket 393 has threaded holes 393t that serve to mount brackets 394 and 395. Fasteners 393f and threaded holes 393t are shown in FIG. 4C. The main PCBA 890 is secured to the upper shell 390 with fasteners 890f (see FIG. 4C); thus, the forces created from using the touchscreen are not transferred to the electronics board. Instead, the loads from pushing on the touchscreen go to the base 300 via the upper shell 390 perimeter and via brackets 394 and 395. The LCD touchscreen assembly 830 connects to the main PCBA 890 board via two ribbon cables. The LCD ribbon 830r connects to the main PCBA 890 at connector 890r, and the touch ribbon 830t connects to the main PCBA 890 at connector 890t.

In some embodiments, the device does not comprise an LCD touchscreen assembly. For example, in certain embodiments, a user may control the device via a computer or other unit (such as, e.g., a smartphone connected to the device via, e.g., a Bluetooth or wireless connection).

In embodiments depicted herein, the upper shell subassembly 5 mates with the base subassembly 2 and is secured with four fasteners that engage the corner threaded holes 390c of the upper shell 390 (see FIG. 1B, FIG. 4B and FIG. 4C). The mid-body of the device 10 is further supported by three fasteners: two fasteners engage the threaded sections 394b of bracket 394, and one fastener engages the threaded section 395b of bracket 395 (see FIG. 4B). In certain embodiments, a elastomer base element 388 can be adhered to the base 300 (see FIG. 1A) to prevent tampering or disassembly.

In the concept development stage, the design started with kinematically aligning the cartridge 60 to the device 10 components by creating a primary datum 30 and maintaining a tight structural loop, as illustrated schematically in FIG. 5A. In FIG. 5A, primary alignment features are represented as solid lines, and secondary alignment dependencies are represented with a dashed line. The direction of each arrow shows the direction of the constraint. For example, the cartridge 60S obtains its position from the dowel pins, not vice versa. As discussed above, the base 300 holds three dowel pins 301A, 301B, and 301C (see, e.g., the embodiment depicted in FIG. 2B and FIG. 2E). In the schematic in FIG. 5A, the base is a monolithic base 300S. Interfacing the monolithic base 300S and the reference dowel pins 301A, 301B, and 301C (interface 31 in FIG. 5A) may be accomplished via a press fit, which allows for precise placement. An RC2 or RC3 fit may be used with Loctite 648 (for example) to further secure the dowel pins 301A, 301B, and 301C. In embodiments where the monolithic base 300S is cast, the cast block is preferably post machined, which will help ensure that the press fit will not crack the material. The engagement depth of the dowel pins 301A, 301B, and 301C can be determined using Saint-Venant's characteristic dimensions guidance. The engagement depth for each pin 301A, 301B, and 301C preferably is at least 1.6× the diameter of the pin; in some embodiments, the engagement depth for each pin 301A, 301B, and 301C is 3× the diameter of the pin. A tolerance stack-up analysis would put the tightest tolerances on the placement of those three press fits, as they serve to align the critical components of the entire device 10. A tolerance stack-up analysis can be performed in conjunction with an error apportionment analysis.

The gantry 302S has alignment features comprising three slots 302a, 302b, and 302c that are oriented to allow for alignment to three dowel pins 301A, 301B, and 301C (see, e.g., the embodiment depicted in FIG. 3B). Thus, in the FIG. 5A schematic, interface 32 comprises kinematic alignment of the three slots 302a, 302b, 302c to the three dowel pins 301A, 301B, and 301C, the tolerance of which can accurately align the gantry 302S to the base 300S (in the X, Y, and rotation about a normal to the surface) in a precise planar fashion and more importantly provide exact kinematic constraint. The three slots'centers are located on a virtual triangle, where the angle bisectors of the triangle's included angles meet at a point that is in the region of greatest alignment accuracy desired between mating elements, and the slots'centers are located on the triangle vertices and their longitudinal axes are aligned with the corresponding angle bisectors at the triangle's vertices.

Depending on the layout of components and/or functional requirements of the device, the kinematic alignment slots may be asymmetric as shown, for example, in FIG. 3B. In other embodiments these kinematic alignment slots may be symmetric as shown, for example, in FIG. 5B.

As another example of alignment features, the main PCBA board 890 aligns to the upper shell 390 via three dowel pins 392, engaging three slots 890s on the PCBA 890. See FIG. 4C.

The interface board 871S aligns to the two dowel pins 301A and 301B using a vee and flat geometry, establishing the primary alignment feature illustrated as interface 33 in FIG. 5A. The three-point contact does not fully constraint the six degrees of freedom of the interface board 871S (see Exact Constraint: Machine Design Using Kinematic Processing, by Douglass Blanding (ISBN-10: 0791800857). Thus, the gantry 302S provides a planar z reference (represented as a secondary alignment dependence), as shown schematically by interface 34 in FIG. 5A. In embodiments described herein, a forty-pin connector 873 (shown as 873S in the FIG. 5A schematic) makes contact with the cartridge PCB 800 (see, e.g., FIG. 1E). The connector 873S aligns to the interface board 871S via two posts (package of connector) on the connector exterior, illustrated as interface 44.

To increase robustness of the design, the cartridge 60S also aligns to the two dowel pins, 301A and 301B, also using a vee and flat geometry, illustrated as a primary alignment feature, interface 35 in FIG. 5A. The cartridge 60S is further constrained by secondary contacts with gantry 302S (illustrated as interface 41) and monolithic base 300S (illustrated as interface 43). The clearances and tolerances between the cartridge 60S, gantry 302S, and monolithic base 300S pre-align the cartridge 60S as it enters the device 10, such pre-alignment can constrain the cartridge 60 to less than 3 degrees after 30 mm (approx. 50%) of engagement. Such analysis of the constraint of the cartridge as it enters the device can be performed geometrically or with CAD software. A plot of the pitch angle of the cartridge as a function of percent engagement of the cartridge can be generated for a specific set of dimensions and manufacturing tolerances, in order to optimize user feedback with costs of production.

The tight structural loop and the kinematic alignments of the vees and flats (interface 35, and interface 33), as well as the gantry slots and pins (interface 32), ensure that the contact (interface 42) between the cartridge 60S and the interface board connectors 873S is consistently accurate.

The kinematic alignment of the slots and pins can be asymmetric as shown in FIG. 3B for the gantry 302, or with a few design modifications can be configured to be symmetric as shown in FIG. 5B. The slot 302c can be moved to the midline between 301A and 301B so that the new slot 302w is centered. The slots 302a and 302b may be replaced with new slots 302z, which are symmetric. The dowel pin 301C can be replaced by a dowel pin 301D that engages the slot 302z of the gantry 302.

The vee and flat also can be used to efficiently align other components during assembly. For example, in the event the heater 700 needs to be precisely aligned to the foam (e.g., Poron®) 703 and heater disk 709, features may be added to each of the three components, so each component aligns to an assembly fixture with two dowel pins. FIG. 5C shows a modified heater plate 709M with a flat region 709t and a v groove 709v, modified poron 703M with a flat region 703t and a groove 703v, and modified heater 750M with a flat region 750t and v groove 750v; such flat regions and v grooves can be used to efficiently align the components.

Alignment between components is discussed by way of reference in Slocum, A. “Kinematic couplings: A review of design principles and applications”, Int. J. of Machine Tools and Manufacture (2009), doi:10.1016/j.ijmachtools.2009.10.006.

It will be appreciated that the devices and methods described above are set forth by way of example, and that the examples do not limit the scope of the invention. In addition, the order or presentation of method or assembly steps in the description above is not intended to require this order of performing the recited steps, unless a particular order is expressly required or is otherwise clear from the context. Thus, while this invention has been particularly shown and described with references to certain embodiments thereof, it will be understood in light of the present disclosure by those skilled in the art that various changes in form and details may be made therein without departing from the scope of the invention, for example as encompassed by the appended claims.

What is claimed is:

1. A device configured to receive a microfluidic cartridge, the device comprising:
(a) a kinematic interface for interfacing the microfluidic cartridge and the device, the kinematic interface comprising a vee and a flat;
(b) a latch that secures the microfluidic cartridge in place after the microfluidic cartridge is inserted into the device;
(c) an actuator configured to activate movement of fluid contained within the microfluidic cartridge; and
(d) a user interface.

2. The device according to claim 1, wherein the user interface comprises an LCD (liquid crystal display) and a touchscreen.

3. The device according to any one of claims 1-2, wherein the device further comprises a barcode reader.

4. The device according to any one of claims 1-3, wherein the device further comprises a clicker that generates a sound when the cartridge has been inserted.

5. The device according to any one of claims 1-4, wherein the device further comprises a heater.

6. The device according to any one of claims 1-4, wherein the device further comprises a controller to control a heating element of the microfluidic cartridge.

7. A device configured to receive a microfluidic cartridge, the device comprising: a base comprising two pins, each of the two pins being oriented on the base such that each pin interfaces with a vee and flat geometry on the microfluidic cartridge.

8. A device comprising:
a base comprising three pins, and
a gantry comprising three slots,
wherein alignment of the three slots with the three pins results in planar and rotational alignment of the base and the gantry.

9. The device according to claim 8, wherein the three slots in the gantry are positioned in the gantry such that their centers lie on a virtual triangle, with each slot's center located on one of the virtual triangle's vertices, and with each slot's longitudinal axis aligned with the one of the angle bisectors of the virtual triangle's included angles, and wherein the angle bisectors of the virtual triangle's included angles meet at a first point that is within the virtual triangle.

10. The device according to claim 8, wherein the device is configured to receive a microfluidic cartridge comprising a vee and a flat that interface with two of the three pins.
